(19) United States
(12) Patent Application Publication
(10) Pub. No.: US 2008/0250509 A1
(43) Pub. Date: Oct. 9, 2008

(54) Write Protection For Memory Devices

(75) Inventor: Marko T. Ahvenainen, Ruutana (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/696,413

(22) Filed: Apr. 4, 2007

(51) Int. Cl. G08B 29/00

(52) U.S. Cl. 726/34

(57) ABSTRACT

Provided is a method for implementing write protection for a non-volatile rewritable memory device, such as a hard disk drive or flash memory module. A write protect command including a first write protect limit address is received, and the first write protect limit address is stored in a register, if it is within an accessible memory area of a memory device. Any subsequent write access to a write protected area is prevented, the write protected area being defined by the first write protect limit address. Associated devices, modules, and systems are also provided.

### RELATED ART

This document is related to a method and device for implementing write protection for a non-volatile rewritable memory device, such as a hard disk drive or flash memory module.

### BACKGROUND ART

Nearly all electronic devices include some kind of storage device for allowing a user and/or applications executed on the device to store data. Storage devices may be permanent or rewritable, such as a ROM element, a flash memory element or a magnetic hard disk drive (HDD), and/or may comprise removable storage media such as any kind of optical, solid state, or magnetic storage medium. In many cases, a non-volatile memory device is provided for applications, programs, and user data. Some of these programs and applications may be written to the rewritable memory device in production, while others may be installed later by a user of the electronic device.

Until recently, magnetic hard disks were mainly used for desktop computers, servers, and similar technologies. However, with technological progress, size and manufacturing cost have decreased considerably, and mobile devices such as mobile phones or other small-scale devices may thus also benefit from this kind of non-volatile data storage device. Also, flash memory elements essentially utilized as hard disks may be used instead of or in addition to a magnetic hard disk drive.

Now, mobile devices may include hard disks or flash memory modules for media and mass data storage, such as media players with sizeable storage capacities. Still, those devices usually include further memory elements such as ROM (read only memory) elements for any data required for operation, such as firmware for device components or a basic installation of an operating system. Since space is valuable in mobile devices, any additional part that has to be included in a device will increase cost and size for the mobile device. But since hard disk drives and similar memory devices do not provide a partial write protection mechanism, it would not be safe to store data of vital importance for a device to such a memory drive included in the device, since a user or an application program could accidentally delete or change this data, practically rendering the device useless in consequence.

Various protocol interfaces may be used for controlling any processes regarding the hard disk or memory element. A common standard in this regard is the ATA/ATAPI standard (Advanced Technology Attachment), also including related designations such as IDE (Integrated Drive Electronics) or UDMA-66 (Ultra Direct Memory Access). Details of this standard may be found e.g. in “Information Technology—AT Attachment with Packet Interface—7”, Volume 1-3, INCITS 397-2005 (1532D), published 14-04-2004. ATAPI makes use of the ATA protocol interface in general, but additionally provides support for CD-ROM drives, tape drives etc. using a subset of SCSI (Small Computer System Interface) commands, which is another common disk drive interface. In this context, specifications such as CE-ATA and ATAonMMC related to ATA with memory cards are well known in the art, as well as Serial ATA (SATA) for use on a high speed serial bus.

In the ATA specification, a functionality is provided for defining a restricted area on a hard disk. Such a “host protected area” may be defined using a low level command issued by the BIOS of a computer device. In particular, a maximum accessible sector address is set by a “set max address” command to the hard drive. Following successful completion of this command, a user or application will not be able to read from or write to any sector beyond the specified maximum sector address. Practically, this functionality defines a “fake” hard disk size which is then used and seen by all applications and devices connected to the hard disk. However, a host protected area cannot be accessed at all and is completely hidden for all applications and requests. That is, not even read access is allowed for these protected areas. Thus, it cannot be used as a storage area for important data such as an operating system or other program code necessary during operation of a device. Also, this area might be cleared when a disk drive is power cycled (i.e. powered off and then on again).

### SUMMARY

According to embodiments of the invention, a set of commands is provided for write protecting at least part of a non-volatile memory device, while allowing read access to all areas. Optionally, the inventive command set may be based on the ATA standard.

According to exemplary embodiments of the invention, the method may comprise transferring information regarding a maximum accessible area on a memory device, in response to a received corresponding request; receiving a write protect command including a first write protect limit address; storing said first write protect limit address in a register, if it is within said maximum accessible area; and preventing any subsequent write access to a write protected area which is defined by said first write protect limit address.

Further, said preventing of write access may in some embodiments include comparing a logical block address received within a write command to said stored first write protect limit address; and preventing said write access requested by said write command if said logical block address is greater than said first write protect limit address. In another embodiment of the invention, said preventing of write access includes comparing a logical block address received within a write command to said stored first write protect limit address; and preventing said write access requested by said write command if said logical block address is less than said first write protect limit address.

In yet another exemplary embodiment of the invention, said write protect command includes a second write protect limit address, and said write protected area is defined as the area between said first and second write protect limit addresses; said preventing of write access then including comparing a logical block address received within a write command to said stored first and second write protect limit addresses; and preventing said write access requested by said write command if said logical block address has a value between said first and second write protect limit addresses. In this way, an upper and a lower limit address may be given in order to define a write protected area lying in between those limit addresses.

According to embodiments of the invention, a write command is any command which causes at least one data block within said accessible memory area to be changed.

In some implementations, said write access is prevented by ignoring a received write command if it is directed to a logical block within said write protected area. This may for example comprise issuing an error signal to said host in order to indicate said prevented write access. Optionally, said issuing of an error signal comprises asserting at least one error bit in a register.

In some embodiments, said write access is prevented by redirecting said write access to at least one unassigned logical block located outside said write protected area.

Further, the method may in some embodiments comprise issuing an error signal to said host if said received write protect limit address is outside said accessible area.

According to exemplary inventive embodiments the method comprises checking whether said received write protect limit address is within an already write protected area. This checking may for example comprise comparing said received write protect limit address to a write protect limit address value previously stored in said register.

In embodiments of the invention, the method may comprise, if said write protect limit address is within said already write protected area, maintaining said previously stored write protect limit address in said register without storing said received write protect limit address. Optionally, this may again comprise issuing an error signal to said host in order to indicate that a required area is already write protected.

In some embodiments of the invention, the method may comprise entering a locked state. This locked state may e.g. be entered on power up of said memory device if at least one write protected area is defined, or for example in response to receiving a write protection lock command. According to some embodiments, during said locked state no write protect commands are allowed. In those and/or other embodiments, during said locked state no changes may be allowed to any write protected areas.

The method may in some embodiments further comprise entering an unlocked state in response to receiving a write protection unlock command. For example, a write command directed to a write protected area may be allowed and executed during said unlocked state in some embodiments of the invention. According to some embodiments, this write command is only allowed if it includes a predefined password. Optionally, said unlocked state is only entered if said write protection unlock command includes a predefined password. Such a password may in exemplary embodiments be previously defined by a set write protect password command.

According to another exemplary embodiment of the invention, the method may further comprise receiving a freeze write protection command; and defining any write protected areas present at the time of receiving said command as permanently write protected. This freeze command may in some implementations be ignored unless it includes a predefined password. As an example, said defining of said write protected areas as being permanently write protected may be implemented by setting a freeze flag bit associated with said at least one limit address of said at least one write protected area.

According to embodiments of the invention, communication to and from said memory device is in accordance with the ATA specification.

In some implementations, the above method steps are performed by a memory device controller.

In exemplary embodiments of the invention, the memory device is a hard disk drive, or a flash memory device. The memory controller may optionally be a disk controller enclosed within a hard disk drive.

In some embodiments of the method, said register is implemented on the magnetic medium of a magnetic hard disk drive. In further exemplary embodiments, the register is implemented on a flash memory element used for storing software and/or firmware of the memory device controller.

According to another aspect of the invention, a method is provided which may according to exemplary embodiments comprise the steps of determining size and location of a required write protected area on a memory device; requesting information on the maximum accessible area of said memory device; receiving said maximum available area information; checking whether said required write protected area is smaller than said maximum accessible area; if said required protected area is smaller than said maximum accessible area, issuing a write protect command including at least a first write protect limit address defining a logical block located within said maximum accessible area.

For example, the write protect limit address defines the first block of said write protected area.

In another example of the invention, the write protect limit address defines the last block of said write protected area.

According to a further exemplary embodiment of the invention, said write protect command further includes a second write protect limit address, and said write protected area is defined as the area between said first and second write protect limit addresses.

In some embodiments, said memory device is a hard disk drive, and said method is performed by a host bus adapter in communication with said hard disk drive. In further embodiments, said memory device is a flash memory element, and said method is performed by a host bus adapter in communication with said flash memory element.

The method may in some exemplary embodiments further comprise requesting whether a previously stored write protect limit address exists for said memory device.

In some embodiments, the requesting of information on a maximum available area comprises issuing an “identify device” command according to ATA specifications. The “identify device” command may in some embodiments be transmitted to a memory device controller.

The method may in exemplary embodiments of the invention further comprise requesting information on whether said memory device supports a write protect feature.

Also, some embodiments of the inventive method may comprise issuing an unlock command before issuing said write protect command. This unlock command may optionally include a predefined password.

In some embodiments of the invention, the method may further comprise issuing an unlock command; and issuing a write command directed to a write protected area. Optionally, the method may further comprise issuing a lock command after said write command has been successfully executed.

According to another exemplary aspect of the invention, a module may be provided comprising at least one memory device and a memory device controller; wherein said memory device controller is configured to receive a write protect command including a write protect limit address; store said write protect limit address in a register; and prevent any subsequent write access to a write protected area which is defined by said write protect limit address. The memory device may e.g. be a hard disk drive, a flash memory used as a hard drive, or any similar memory element.

The register may in some embodiments be implemented on the magnetic storage medium of a hard disk drive. The register may in some further embodiments be implemented on a flash memory element used for storing software and/or firmware of said disk controller.

According to another aspect, a system is provided which may in exemplary embodiments comprise the above module, and further comprise a host bus adapter in communication with said memory device controller via a device bus; and a processing unit connected to said host bus adapter via a processor bus. In some embodiments of an inventive system, said device bus is in conformity with the ATA specification.

Further, a mobile device may be provided which may comprise at least one module as described above. The mobile device may for example be a mobile phone, a personal digital assistant, or a media player.

According to an further exemplary embodiment of the invention, a device may be provided comprising means for non-volatile data storage; means for transferring information regarding a maximum accessible area on said storage means, in response to a corresponding request; means for receiving a write protect command including at least one write protect limit address; means for storing said at least one write protect limit address, if it is within said maximum accessible area; and means for preventing any subsequent write access to a write protected area which is defined by said write protect limit address.

As will be evident to the person skilled in the art, any combinations and sub-combinations of the above exemplary embodiments are also within the scope of this invention.

### BRIEF DESCRIPTION OF DRAWINGS

In the following, exemplary embodiments of the invention will be described in more detail with reference to the appended figures, wherein

FIG. 1 shows an exemplary hard disk—host system which may be used in inventive embodiments;

FIG. 2a to 2c show several exemplary data structures that may be present on a write protected memory device according to the invention;

FIG. 3 is an illustration of an exemplary command scheme for an inventive embodiment; and

FIG. 4 shows by way of example contents of memory device feature registers for implementing the inventive method.

### DETAILED DESCRIPTION OF INVENTIVE EMBODIMENTS

Various embodiments of the invention may be utilized in devices. In particular, electronic computer devices may use memory devices according to the invention such as hard disk drives as a mass storage utility for large amounts of data. When devices are intended for mobile use and thus benefit from minimal space requirements and weight, use of the inventive method and/or device may help to reduce memory components in the device, since additional ROM (read-only memory) elements may be omitted or at least minimized. However, the inventive method and device may of course be used with any kind of electronic device that uses at least one non-volatile, rewritable memory device for storage.

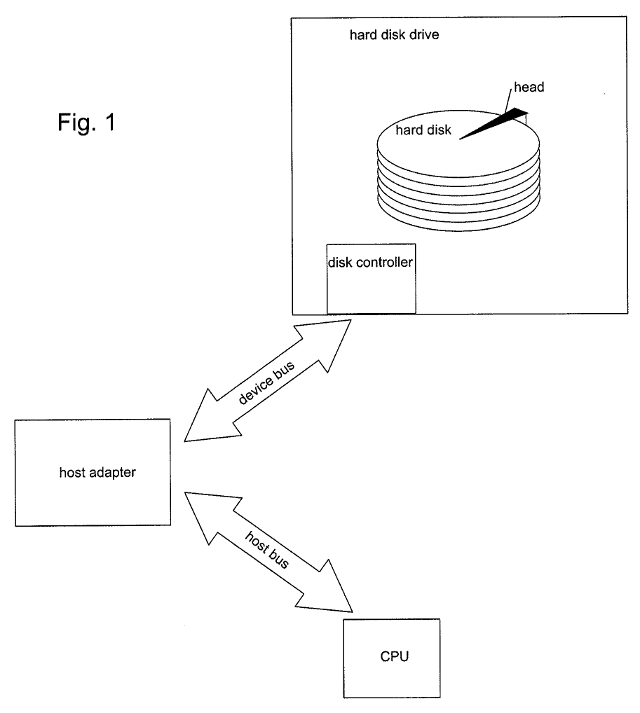

In an exemplary device using an embodiment of the inventive method, at least one memory device such as a hard disk may be included for data storage. Several hard disks (or other memory devices) may be combined in a device, forming a disk array, to achieve e.g. higher storage capacity and/or operation reliability in case of failure. It shall be noted that magnetic hard disks are used as an example for illustration only, and that other analogous devices, such as flash memory devices, may be employed for the invention in similar ways. FIG. 1 shows an exemplary view of a hard disk drive connected to a host via a host adapter. A hard disk is a non-volatile storage device which stores digitally encoded data on rapidly rotating platters having magnetic surfaces. The platters may consist of a flat glass or aluminum disk, coated with a thin layer of magnetic material. An actuator arm may be used to move an inductive head element in a short distance over the magnetic surface to specific locations in order to write and read information on the platter by magnetizing a disk sector or by detecting a magnetic field of a sector. In this way, information may be encoded on the hard disk using small disk sectors with a defined magnetic field. Further details of magnetic storage devices such as hard disks and similar arrangements are well known in the art and will easily be adapted for purposes of this invention by a person skilled in the art. In case of a flash memory device, information is stored using large arrays of floating gate transistors by changing the level of electrical charge, instead of magnetizing disk areas. One transistor usually allows storing one bit of information, but devices storing more than one bit per transistor are also available. Depending on the type of flash memory, the logical memory area may be accessed either in single bits or bytes, or in larger segments called sectors or blocks similar to a magnetic disk drive.

In order to allow data communication between the memory device and a host, an interface may be provided which connects the memory device to a host. The host may include a central processing unit and/or additional devices, such as PCI (Peripheral Component Interconnect) devices. A host adapter (also referred to as host bus adapter) may be provided for communication between a host and a memory device such as the hard disk of FIG. 1.

Additionally, a disk controller comprising drive electronics and logic fields may be implemented in the memory device itself, as is common with ATA devices. The disk controller residing e.g. in the hard disk drive is not to be confused with the host adapter, which may also be referred to as host controller or ATA/IDE controller (in case of an ATA interface) and provides a connecting bridge between the host bus and the device bus. It shall be noted that a hard drive according to these explanations not necessarily only includes magnetic disk drives, but also any other memory device such as a flash memory module which functions as a hard drive.

It will be understood for the person skilled in the art that the ATA/ATAPI protocol used for explanatory purposes in this description is only cited by way of example and for allowing a thorough understanding of the overall inventive concept. Commands, data structures, and communication sequences described herein may easily be transferred to any other suitable protocol or command scheme used for controlling memory devices. Also, hardware requirements and/or interface implementation may vary in accordance with the respective standard used for device attachment.

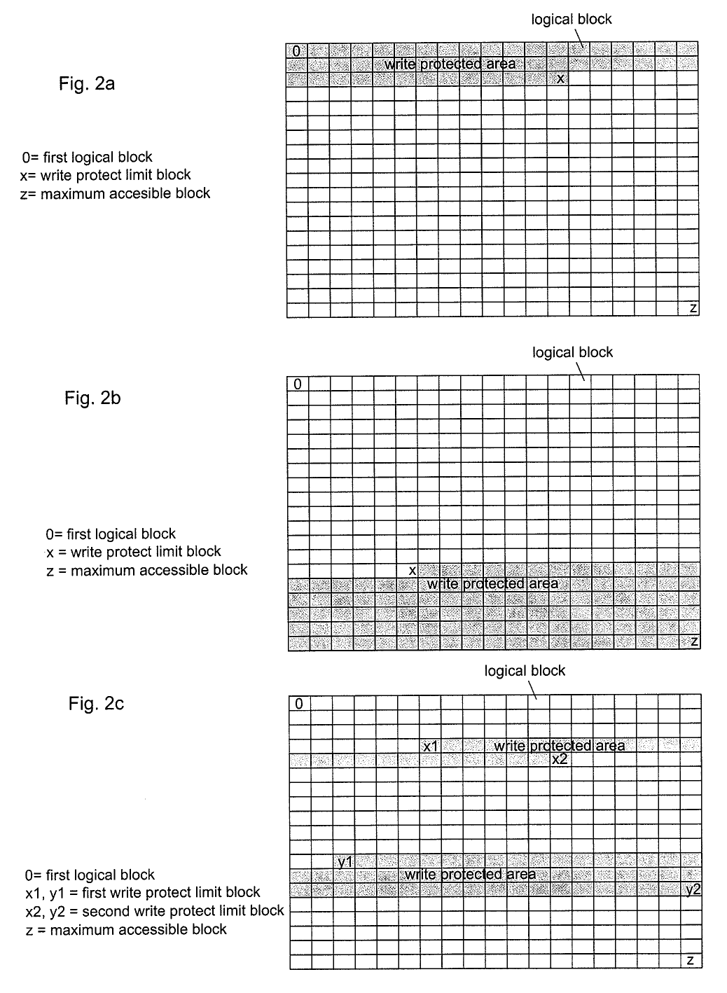

FIG. 2 shows various schematic illustrations of a data structure that may be present on a memory device in exemplary inventive embodiments. It shall be understood that these diagrams are for illustrative purposes only and cannot be seen as an actual representation of a memory device data structure. Number and arrangement of “sectors” have been chosen arbitrarily. Each small square of the overall “memory area” may represent a certain portion of the memory area, which portion is not specified any further. In particular, these memory portions or sections shall not necessarily be equated with a block as the term is used in the ATA specification. When data is to be written and/or read from a magnetic platter of a hard disk drive, from a flash memory element or any other memory device, an addressing scheme is required for locating the desired sectors. Earlier versions of ATA have applied a cylinder head sector (CHS) addressing scheme for hard disk drives. There, each platter of a magnetic hard disk may be divided into concentric “tracks”, and when considering all platters of the disk arranged on top of each other, a “cylinder” is defined by the plurality of all vertically aligned tracks of these platters. Each platter is then further divided into individual circular “sectors”. For each magnetic platter surface, a separate head is provided, and thus one specific block of data on a hard disk drive can be addressed by specifying a cylinder, a head and a circle sector. Usually, the single data block which is determined by a cylinder and an intersecting circular sector is called a “sector” and defines the smallest storage unit that can be accessed on a hard disk, typically holding 512 bytes of data. This CHS addressing scheme has mostly been replaced by the logical block addressing (LBA) scheme, where sectors of a hard disk or any memory device are simply numbered consecutively, that is, the sectors are mapped linearly to addresses. This scheme may not only be applied to magnetic hard disks, but also to other memory devices such as solid state/flash memories. LBA is also the addressing scheme used for the examples described herein. Of course, other addressing schemes may be used for purposes of this invention in a similar way.

According to embodiments of this invention, at least a part of the memory device may be write protected by means of a write protection command that is transmitted to the memory device controller. That is, no write access will be allowed for the blocks located in this write protected memory area, while read-only access will still be possible for this part of the disk. All other parts of the memory device may be accessed and changed as usual. While in this example only a small part of the logic memory device area is write protected, a larger portion or even the complete memory device may be write protected using embodiments of this invention. When only at least one portion of the memory device is write protected, this allows to partition the memory space into two or more logical disks, one having only read capability and all further logical disks functioning as normal read/write access space. In the read-only part of the memory device, that is the write protected area, important data may be stored without the risk of accidental deletion or modification. Such data may include program code of an operating system, manufacturer data (e.g. for marketing purposes), built-in applications (e.g. games, information managers), operator data (e.g. for communication devices in order to establish connections) and the like. The write protected area may also be extended when necessary by issuing another write protect command for the respective area.

In one embodiment of the invention, a write protected area is defined by specifying a memory address from which on write/read access is allowed. The resulting data structure is shown in FIG. 2a. Thus, write accesses will be rejected for any block/sector having an address below the one specified in the write protect command, which address is herein referred to as a write protect limit address x. The write protect command including the write protect limit address may be received at the memory device controller and stored in a register. This register may be queried whenever write accesses are performed. In this way it may be checked whether a block address given in a write command is valid, i.e. the write access is allowed, or is located within a write protected area. A “write command” or “write access” shall for purposes of this description include any command, request or access to the memory device which involves writing of data to at least one data unit, or changing of data in at least one data unit. If the given block address is smaller than the write protect limit address and thus refers to a write protected data block, the disk controller may in one embodiment assert one predetermined bit of an error register in order to inform the host of the unsuccessful write access. In another embodiment, the disk controller or alternatively the host adapter may re-direct the write command to any unassigned block outside the write protected area. Read accesses received by the disk controller are not affected by this and may be executed as usual.

In a further embodiment of the invention as illustrated in FIG. 2b, a write protected area may alternatively be defined by specifying a disk address x up to which write/read access is allowed, with all blocks after that address being write protected. The above considerations regarding the effects and processes of write protection apply to this case as well. For the person skilled in the art, it will be easy to transfer the examples given in this description to such a variation of disk structure. In the example shown in FIG. 2b, the limit address specified indicates the last writeable block, but in other embodiments, the address may also indicate the first block of the area to be protected.

While in the above embodiments, only a single limit address x is necessary for defining a write protected area on a memory device, it may also be possible to define write protected areas not at the beginning or end of the available memory area. Thus, two write protect limit addresses x1 and x2 are allowed in another embodiment, defining a lower and an upper limit for a write protected area. This example case is shown in FIG. 2c. One of the limit addresses may be set to a default value, e.g. the lower limit address might be set to zero in one embodiment. If then only an upper limit address is specified by a write protect command, this will achieve the same result as the above described example shown in FIG. 2a, where a write protected area is defined at the beginning of the memory device. Lower and upper limit addresses may be transmitted in a single write protection command or alternatively in two different commands. It will be evident to the person skilled in the art that the above explanations apply to this case as well, the write protected area being defined between these two limit addresses. Also, further write protected areas may be defined by additional write protect commands, as shown with further write protect limit addresses y1 and y2.

When a write protect command is issued by the host adapter, it has to be ensured that the write protect limit address given in the command will not exceed the maximum sector address z. This address, corresponding to the size of the accessible memory area, may in the ATA example be queried by the “IDENTIFY DEVICE” command, which amongst others returns the highest address value valid for the memory device. It shall be noted that this address value is the highest “visible” sector or block, not including a potential host protected area; thus, write protect commands may be accepted with any value which is smaller than the address value returned by the “IDENTIFY DEVICE” command. This is only one example that may be used for retrieving the accessible memory size; other commands or queries are conceivable, in particular when other protocols than ATA are used for write protection of a memory device. A further command or command parameter may be defined which allows a host to query the current write protect limit address and thus the size and location of the write protect area.

If additional write protected storage area is required at a later point in time, the existing write protected area may be extended according to another exemplary embodiment of the invention. This may easily be achieved by issuing another write protect command with a single write protect limit address outside the existing write protected area. In response to such a command, the new write protect limit address will be stored and thus define an extended write protected area. For the example case where the write protect limit address defines the last writable block (or, optionally, the first read-only block), the new write protect limit address has to be less than the previously stored write protect address. When a write protect command is received by the memory device controller, a check may be performed to see whether the write protect limit address specified in the command has a valid value. If the write protect limit address of the command is directed to an already write protected area, i.e. in the cited example a limit address greater than the stored write protect limit address, the command may e.g. be ignored and not have any effects. Optionally, an error signal may be issued to the host adapter, indicating that the required address is already within a write protected area.

A register for storing the write protect limit addresses, or in general any exchanged parameters for a write protect feature, may be implemented as a hardware or software register within the memory device controller (e.g. in a flash memory unit of the controller), but may alternatively also be stored directly in the storage area of the memory device, for example within the magnetic storage area of a hard disk or in the drive area of a flash memory drive.

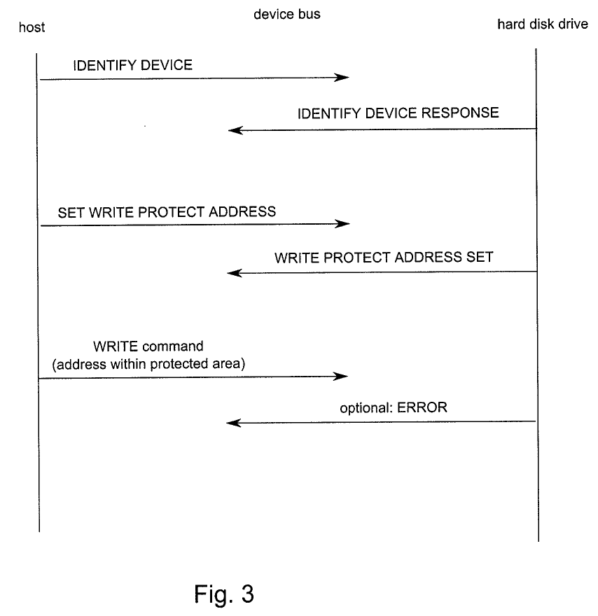

In FIG. 3, an exemplary command scheme is shown that may be used according to embodiments of the invention for defining a write protected area on a memory device. In this case, an ATA conform hard disk drive is used as an example, but the general command sequence may also be applied to any similar memory device.

After attachment or start up, an “identify device” command may be issued by the host to the device, which is answered by an identify device response from the hard disk controller to the host. The response may contain various information regarding the device, i.e. the hard disk. For example, in an ATA conform communication, this response may include a value indicating the maximum accessible area of said hard disk by giving the highest accessible block address.

According to an embodiment of the invention, this information may further include an indication of whether the hard disk supports a write protect feature. Such an indication may e.g. consist of an asserted bit in a predefined register. In this way, the host adapter may detect whether any write protection commands are allowed with this device. Furthermore, the transmitted device information may optionally contain a previously set write protect limit address if some part of the hard disk has already been write protected.

If the host (or host adapter) has assured that write protection features are supported, a write protect command may be issued whenever necessary. This command may e.g. be initiated automatically by an application, or manually by user input, such as an administrator wishing to protect installation files of an operating system. Within the write protect command, a write protect limit address has to be specified according to an embodiment of the invention. This write protect limit address defines the disk area to be write protected. As mentioned above, a limit address may be applied in different ways. For example, this address may define the first logical block of the hard disk which allows write access, or alternatively the last logical block of the write protected read-only disk area. This will have the effect that all blocks below this block address will be read-only. In another embodiment, the specified write protect limit address may define the first block of the hard disk which is write protected or the last logical block which is open for read-write access, such that the write protected area will be located at the (logical) end portion of the disk.

The write protect command may be transmitted to the hard disk controller, including the required write protect limit address. The disk controller may optionally check whether the specified address is valid, or whether the address is within an already write protected area. Then, the write protect limit address may be stored in a register of the hard disk. This register may be queried whenever a write command is received at the hard disk. In response to a write protect command, an acknowledgment may be indicated to the host adapter to report a successful completion of the write protection, or an error signal when the command could not be executed. Such an error signal or acknowledgment may be indicated in different ways, as will be evident for the person skilled in the art. For example, a register bit could be set to a predetermined value, or a predefined message may be transferred to the host adapter.

When a write protected area has been set and a write command is received subsequently, write access to the hard disk will be prevented by the disk controller if the logical block address specified within the write command is within the write protected area. Again, a specific error signal may be issued to the host adapter if the write command cannot be executed.

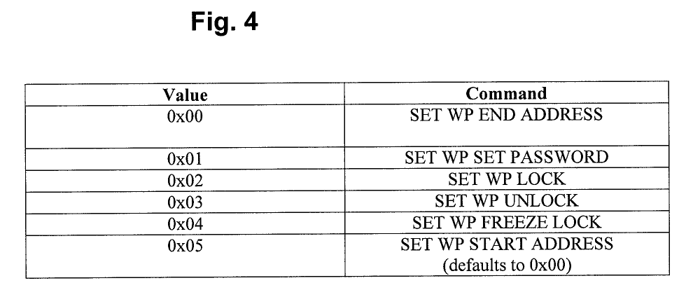

FIG. 4 shows an exemplary inventive register structure for ATA device registers. Command features may be defined and controlled by the feature register. The features shown in FIG. 4 are only provided by way of example and do not limit the features of a write protect function to those features. Rather, additional features may be provided, features may be replaced by other features, or omitted. The values shown, indicating the respective commands are also used as example values only and may easily be replaced by other values. In general, a single command providing a write protect limit address for defining an area to be write protected would be sufficient for one exemplary embodiment of the invention. In the example shown, additional command features are included which will be described in the following. As a first example command, a SET WP END ADDRESS command defining a write protect end address is provided. Using this command, an address may be transmitted to the controller structure in order to determine the last block of a write protected area. As mentioned, this first command may be sufficient for a basic embodiment of the invention, allowing a single write protected area at the beginning of the memory device.

According to some embodiments of the invention, a locked state may be defined. If a write protected area exists, a device will directly enter the locked state after power up. Also, a device may automatically or on request, using an LOCK command (shown in the command table as “SET WP LOCK”), enter the locked state from a previous unlocked state. When the memory device is in locked state, the respective write protected areas which have previously been set by a SET WP LIMIT ADDRESS command can be accessed, but not rewritten in any form. In addition, these protected areas cannot be resized in an exemplary embodiment during locked state. Depending on the implementation, it may be allowed to set additional write protected areas in the locked state by the SET WP LIMIT ADDRESS command. A complementary UNLOCK command may be defined to leave this locked state and enter an unlocked state where changes to write protected areas are possible.

In order to avoid changes to the write protected areas, a password function may be used according to an exemplary embodiment of the invention for controlling access to write protected areas. This may be realized e.g. by defining a password using a SET PASSWORD command, which may then optionally be stored in a non-volatile memory, or even in a portion of the memory device to be write protected itself. Storing the password allows to keep the access control even when a device is powered down and/or reset is performed. For unlocking the write protect function or in general for entering the unlocked state, the password would be necessary, and until the password is entered or transmitted to the memory device in a respective command, no write protected area could be set and/or altered in any way.

For prohibiting that any program or a user interferes with the write protect function at all, it may in some embodiments be possible to lock the write protection function itself, such that it is not possible to define further write protected areas and/or to alter existing write protected areas. This may also be achieved by the locked state above, which may again be initiated by a LOCK command. When the device is in locked state, it would be necessary to enter unlocked state (with or without password protection, but usually with password to prevent unauthorized use) before write protected areas can be set, changed, or optionally accessed. This would prevent that a malicious program or a user accidentally issues an undesired write protect command to an area which is used for writing data.

After an unlocked state has been entered, it may according to some embodiments be allowed to directly write to write protected areas, such that write commands are processed as usually without checking whether the area is protected. This may be used e.g. for software updates to an operating system stored in a write protected area. In an alternative example embodiment, write accesses to write protected areas may not be allowed in general, not even in unlocked state.

Should it be necessary to write data to a write protected area, some embodiments may provide that a password has to be included into a write command to write to a protected area, even in unlocked state. This would achieve a double protection feature, allowing to query passwords both when entering an unlocked state and when writing to a write protected area in unlocked state. It may also prevent that a malicious program writes to a protected area unnoticed during the time a host has entered unlocked state for e.g. allowing a firmware update. In other embodiments, it might be required to resize or suspend the write protection of the requested memory section in order to write data, and then subsequently to re-protect the area.

If the limit address(es) specified in a valid write protect command is/are not within a currently write protected area, the area will be set as write protected as described above. In this context, the write protect command is regarded as valid when either the memory device is in unlocked state or when it is allowed to set write protected areas in locked state. When the unlocked state is entered (with or without a respective password for unlocking), write protected areas might also be changed in size. This may in an exemplary embodiment be achieved by allowing all write protect limit addresses in a SET WP command. When one or both of the addresses then fall into an already existing write protected area, the respective area will be resized accordingly. That is, when the lower limit address is within an already protected area, while the upper limit address defines the last block of the already protected area, the area may be decreased to this size.

Similarly, when e.g. the lower limit address would be within the already protected area, and the upper limit address is higher than the current upper limit of the protected area, this will result in a shifting and potential resizing of the write protected area. In other embodiments or generally in situations where it is not allowed to resize protected areas e.g. in locked state, any command trying to set a new write protect area which at least partially coincides with an already existing write protected area will return an error signal.

If it is desired in some embodiments to permanently write protect at least one area of the memory device, a FREEZE command may be provided. Using this command, write protected areas existing at the moment of issuing the command may be made permanent such that they cannot be changed any more, not even in an unlocked state. When the unlocked state is entered at any time after a FREEZE command has been issued and thus some write protected areas have been made permanent, only new areas may be write protected, and/or write protected areas added after the FREEZE command may still be altered as described above. The memory device may e.g. add a flag bit to the write protect limit addresses stored, which indicates whether an area defined by those limit addresses has been frozen and is therefore permanent. This freeze flag bit may thus only be changed one single time and cannot be switched back to the non-frozen state indication. Other provisions and alternatives for this purpose, i.e. for indicating whether a write protected area is permanent or not, will easily be conceived by the person skilled in the art.

In some embodiments, only one continuous write protected area may be allowed. Such a single write protected area may still include temporarily protected parts and also permanently protected parts, which may have been made permanent by using a freeze command as described above, but all parts are connected. In the example embodiment described before having a write protected area at the beginning of a memory area, a first write protected area may have been defined. When a valid freeze command is issued, this existing protected area will be set to permanent protection and cannot be changed any more. Subsequently, at least one further write protected area may be defined as an extension of the first one by issuing a write protect command with an higher write protect limit address. This further area may in some embodiments still be changed, e.g. in an unlocked state, or another area may be added behind. In this way, a single write protected area may emerge which has both permanent and non-permanent write protected parts.

Although exemplary embodiments of the present invention have been described, these should not be construed to limit the scope of the appended claims. Those skilled in the art will understand that various modifications may be made to the described embodiments and that numerous other configurations or combinations of any of the embodiments are capable of achieving this same result. Moreover, to those skilled in the various arts, the invention itself will suggest solutions to other tasks and adaptations for other applications. It is the applicant's intention to cover by claims all such uses of the invention and those changes and modifications which could be made to the embodiments of the invention herein chosen for the purpose of disclosure without departing from the spirit and scope of the invention.

What is claimed is:

1. A method comprising
receiving a write protect command including a first write protect limit address;
storing said first write protect limit address in a register, if it is within an accessible memory area of a memory device;
preventing any subsequent write access to a write protected area which is defined by said first write protect limit address.

2. The method of claim 1, wherein said preventing of write access includes
comparing a logical block address received within a write command to said stored first write protect limit address; and
preventing said write access requested by said write command if said logical block address is greater than said first write protect limit address.

3. The method of claim 1, wherein said preventing of write access includes
comparing a logical block address received within a write command to said stored first write protect limit address; and
preventing said write access requested by said write command if said logical block address is less than said first write protect limit address.

4. The method of claim 1,
wherein said write protect command includes a second write protect limit address, and wherein said write protected area is defined as the area between said first and second write protect limit addresses; said preventing of write access including
comparing a logical block address received within a write command to said stored first and second write protect limit addresses; and
preventing said write access requested by said write command if said logical block address has a value between said first and second write protect limit addresses.

5. The method of claim 1, further comprising transferring information regarding a maximum accessible area on a memory device, in response to a received corresponding request.

6. The method of claim 1, wherein said write access is prevented by ignoring a received write command if it is directed to a logical block within said write protected area.

7. The method of claim 6, further comprising issuing an error signal to said host in order to indicate said prevented write access.

8. The method of claim 1, wherein said write access is prevented by redirecting said write access to at least one unassigned logical block located outside said write protected area.

9. The method of claim 1, further comprising
issuing an error signal to said host if said received write protect limit address is outside said accessible area.

10. The method of claim 1, further comprising
checking whether said received write protect limit address is within an already write protected area, and
if said write protect limit address is within said already write protected area,
maintaining said previously stored write protect limit address in said register without storing said received write protect limit address.

11. The method of claim 1, further comprising
entering a locked state;
wherein said locked state is entered on power up of said memory device if at least one write protected area is defined, and/or said locked state is entered in response to receiving a write protection lock command.

12. The method of claim 11, wherein during said locked state no write protect commands are allowed.

13. The method of claim 11, wherein during said locked state no changes are allowed to any write protected areas.

14. The method of claim 11, further comprising entering an unlocked state in response to receiving a write protection unlock command.

15. The method of claim 14, wherein a write command directed to a write protected area is allowed and executed during said unlocked state.

16. The method of claim 15, wherein said write command is only allowed if it includes a predefined password.

17. The method of claim 14, wherein said unlocked state is only entered if said write protection unlock command includes a predefined password.

18. The method of claim 17, wherein said password is previously defined by a set write protect password command.

19. The method of claim 1, further comprising
receiving a freeze write protection command; and
defining any write protected areas present at the time of receiving said command as permanently write protected.

20. The method of claim 19, wherein said freeze command is ignored unless it includes a predefined password.

21. The method of claim 19, wherein said defining of said write protected areas as being permanently write protected is implemented by setting a freeze flag bit associated with said at least one limit address of said at least one write protected area.

22. The method of claim 1, wherein communication to and from said memory device is in accordance with the ATA specification.

23. The method of claim 1, wherein said method is performed by a memory controller.

24. The method of claim 1, wherein said memory device is a hard disk drive.

25. The method of claim 1, wherein said memory device is a flash memory device.

26. The method of claim 23, wherein said memory controller is a disk controller enclosed within a hard disk drive.

27. The method of claim 1, wherein said register is implemented on the magnetic medium of a magnetic hard disk drive.

28. The method of claim 23, wherein said register is implemented on a flash memory element used for storing software and/or firmware of said controller.

29. A method comprising
determining size and location of a required write protected area on a memory device;
requesting information on the maximum accessible area of said memory device;
receiving said maximum available area information;
checking whether said required write protected area is smaller than said maximum accessible area;
if said required protected area is smaller than said maximum accessible area, issuing a write protect command including at least a first write protect limit address defining a logical block located within said maximum accessible area.

30. The method of claim 29, wherein said write protect limit address defines the first block of said write protected area.

31. The method of 29, wherein said write protect limit address defines the last block of said write protected area.

32. The method of claim 29, wherein said write protect command further includes a second write protect limit address, and wherein said write protected area is defined as the area between said first and second write protect limit addresses.

33. The method of claim 29, wherein said memory device is a hard disk drive, and wherein said method is performed by a host bus adapter in communication with said hard disk drive.

34. The method of claim 29, wherein said memory device is a flash memory element, and wherein said method is performed by a host bus adapter in communication with said flash memory element.

35. The method of claim 29, further comprising
requesting information on whether said memory device supports a write protect feature.

36. The method of claim 29, further comprising
issuing an unlock command before issuing said write protect command.

37. The method of claim 36, wherein said unlock command includes a predefined password.

38. The method of claim 29, further comprising
issuing an unlock command; and
issuing a write command directed to a write protected area.

39. The method of claim 38, further comprising
issuing a lock command after said write command has been successfully executed.

40. A module comprising
at least one memory device and a memory device controller;
wherein said memory device controller is configured to
receive a write protect command including a write protect limit address;
store said write protect limit address in a register; and
prevent any subsequent write access to a write protected area which is defined by said write protect limit address.

41. The module of claim 40, wherein said register is implemented on a magnetic storage medium of a hard disk drive.

42. The module of claim 40, wherein said register is implemented on a flash memory element used for storing software and/or firmware of said memory device controller.

43. A system comprising the module of claim 40, and further comprising a host bus adapter in communication with said memory device controller via a device bus; and
a processing unit connected to said host bus adapter via a processor bus.

44. The system of claim 43, wherein said device bus is in conformity with the ATA specification.

45. A mobile device comprising at least one module according to claim 40.

46. The device of claim 45, wherein the mobile device is a mobile phone, a personal digital assistant or a media player.

47. A device comprising
means for non-volatile data storage;
means for transferring information regarding a maximum accessible area on said storage
means, in response to a corresponding request;
means for receiving a write protect command including at least one write protect limit address;
means for storing said at least one write protect limit address, if it is within said maximum accessible area; and
means for preventing any subsequent write access to a write protected area which is defined by said write protect limit address.
